(19) United States
(12) Patent Application Publication
(10) Pub. No.: US 2024/0340918 A1
(43) Pub. Date: Oct. 10, 2024

(54) METHODS AND APPARATUSES FOR UPLINK TRANSMISSION ENHANCEMENT

(71) Applicant: FG Innovation Company Limited, Tuen Mun (HK)

(72) Inventors: Po-Chun CHOU, Taipei (TW); Mei-Ju SHIH, Taipei (TW); Yen-Hua LI, Taipei (TW); Chia-Hung LIN, Taipei (TW)

(21) Appl. No.: 18/630,888

(22) Filed: Apr. 9, 2024

Related U.S. Application Data
(60) Provisional application No. 63/458,201, filed on Apr. 10, 2023.

(51) Int. Cl. H04W 72/232; H04L 5/00

(52) U.S. Cl. CPC H04W 72/232; H04L 5/0048; H04L 5/0064

(57) ABSTRACT

Methods and apparatuses for Uplink (UL) transmission enhancement are provided. The method includes receiving, from a Base Station (BS), a Radio Resource Control (RRC) message including a Physical Uplink Shared Channel (PUSCH) configuration; receiving, from the BS, a Downlink Control Information (DCI) format including at least one of: a first field that indicates an 8-port Sounding Reference Signal (SRS) resource, a second field that includes an index associated with a precoding matrix transmission, a third field that indicates a first set of parameters for transmitting a first codeword, and a fourth field that indicates a second set of parameters for transmitting a second codeword; determining a precoding matrix based on the DCI format and the PUSCH configuration; and performing a codebook-based PUSCH transmission using the precoding matrix.

### CROSS-REFERENCE TO RELATED APPLICATION(S)

The present disclosure claims the benefit of and priority to U.S. Provisional Patent Application Ser. No. 63/458,201, filed on Apr. 10, 2023, entitled “METHOD AND APPARATUS TO ENHANCE 8TX UL TRANSMISSION,” the content of which is hereby incorporated herein fully by reference into the present disclosure for all purposes.

### FIELD

The present disclosure is related to wireless communication and, more specifically, to methods and apparatuses for Uplink (UL) transmission enhancement.

### BACKGROUND

Various efforts have been made to improve different aspects of wireless communication for cellular wireless communication systems, such as the 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the art.

### SUMMARY

The present disclosure is related to methods and apparatuses for Uplink (UL) transmission enhancement.

According to a first aspect of the present disclosure, a method performed by a User Equipment (UE) for Uplink (UL) transmission enhancement is provided. The method includes receiving, from a Base Station (BS), a Radio Resource Control (RRC) message including a Physical Uplink Shared Channel (PUSCH) configuration; receiving, from the BS, a Downlink Control Information (DCI) format including at least one of: a first field that indicates an 8-port Sounding Reference Signal (SRS) resource, a second field that includes an index associated with a precoding matrix transmission, a third field that indicates a first set of parameters for transmitting a first codeword, and a fourth field that indicates a second set of parameters for transmitting a second codeword; determining a precoding matrix based on the DCI format and the PUSCH configuration; and performing a codebook-based PUSCH transmission using the precoding matrix.

In some implementations of the first aspect of the present disclosure, the first set of parameters includes a first Modulation and Coding Scheme (MCS) associated with the first codeword, a first New Data Indicator (NDI) associated with the first codeword, and a first Redundancy Version (RV) associated with the first codeword, and the second set of parameters includes a second MCS associated with the second codeword, a second NDI associated with the second codeword, and a second RV associated with the second codeword.

In some implementations of the first aspect of the present disclosure, the PUSCH configuration includes a field indicating a maximum transmission rank for the codebook-based PUSCH transmission. The method further includes determining whether a value of the field is larger than four; determining that a two-codeword transmission function is enabled in response to determining that the value of the field is larger than four; and in response to determining that the two-codeword transmission function is enabled, prohibiting the UE from transmitting both the first codeword and the second codeword in the codebook-based PUSCH transmission in a case that an index of the first MCS is set to 26 and a value of the first RV is set to 1, or an index of the second MCS is set to 26 and a value of the second RV is set to 1.

In some implementations of the first aspect of the present disclosure, the method further includes determining that the two-codeword transmission function is disabled in response to determining that the value of the field is equal to or less than four; and determining that the fourth field is absent from the DCI format in response to determining that the two-codeword transmission function is disabled.

In some implementations of the first aspect of the present disclosure, the PUSCH configuration includes a PUSCH-Config Information Element (IE) that includes a txConfig field set to a value of ‘codebook.’

In some implementations of the first aspect of the present disclosure, the PUSCH configuration includes a PUSCH-Config Information Element (IE) that includes information associated with a number of maximum transmission ranks, a transform precoding configuration, and a codebook subset configuration.

In some implementations of the first aspect of the present disclosure, determining the precoding matrix based on the DCI format includes determining a dedicated table, which includes the precoding matrix, based on the number of maximum transmission ranks, the transform precoding configuration, and the codebook subset configuration in the PUSCH-Config IE.

In some implementations of the first aspect of the present disclosure, the number of maximum transmission ranks is one of 1, 2, 4, and 8, and the codebook subset configuration includes one or more allowed codebook subsets and antenna group information.

In some implementations of the first aspect of the present disclosure, the first field includes an SRS resource indicator field.

In some implementations of the first aspect of the present disclosure, the second field is associated with precoding information and a number of layers.

According to a second aspect of the present disclosure, a User Equipment (UE) for Uplink (UL) transmission enhancement is provided. The UE includes at least one processor and at least one non-transitory computer-readable medium coupled to the at least one processor. The at least one non-transitory computer-readable medium stores one or more computer-executable instructions that, when executed by the at least one processor, cause the UE to receive, from a Base Station (BS), a Radio Resource Control (RRC) message including a Physical Uplink Shared Channel (PUSCH) configuration; receive, from the BS, a Downlink Control Information (DCI) format including at least one of: a first field that indicates an 8-port Sounding Reference Signal (SRS) resource, a second field that includes an index associated with a precoding matrix transmission, a third field that indicates a first set of parameters for transmitting a first codeword, and a fourth field that indicates a second set of parameters for transmitting a second codeword; determine a precoding matrix based on the DCI format and the PUSCH configuration; and perform a codebook-based PUSCH transmission using the precoding matrix.

In some implementations of the second aspect of the present disclosure, the first set of parameters includes a first Modulation and Coding Scheme (MCS) associated with the first codeword, a first New Data Indicator (NDI) associated with the first codeword, and a first Redundancy Version (RV) associated with the first codeword, and the second set of parameters includes a second MCS associated with the second codeword, a second NDI associated with the second codeword, and a second RV associated with the second codeword.

In some implementations of the second aspect of the present disclosure, the PUSCH configuration includes a field indicating a maximum transmission rank for the codebook-based PUSCH transmission, and the one or more computer-executable instructions, when executed by the at least one processor, further cause the UE to determine whether a value of the field is larger than four; determine that a two-codeword transmission function is enabled in response to determining that the value of the field is larger than four; and in response to determining that the two-codeword transmission function is enabled, prohibit the UE from transmitting both the first codeword and the second codeword in the codebook-based PUSCH transmission in a case that an index of the first MCS is set to 26 and a value of the first RV is set to 1, or an index of the second MCS is set to 26 and a value of the second RV is set to 1.

In some implementations of the second aspect of the present disclosure, the one or more computer-executable instructions, when executed by the at least one processor, further cause the UE to determine that the two-codeword transmission function is disabled in response to determining that the value of the field is equal to or less than four; and determine that the fourth field is absent from the DCI format in response to determining that the two-codeword transmission function is disabled.

In some implementations of the second aspect of the present disclosure, the PUSCH configuration includes a PUSCH-Config Information Element (IE) that includes a txConfig field set to a value of ‘codebook.’

In some implementations of the second aspect of the present disclosure, the PUSCH configuration includes a PUSCH-Config Information Element (IE) that includes information associated with a number of maximum transmission ranks, a transform precoding configuration, and a codebook subset configuration.

In some implementations of the second aspect of the present disclosure, determining the precoding matrix based on the DCI format includes determining a dedicated table, which includes the precoding matrix, based on the number of maximum transmission ranks, the transform precoding configuration, and the codebook subset configuration in the PUSCH-Config IE.

In some implementations of the second aspect of the present disclosure, the number of maximum transmission ranks is one of 1, 2, 4, and 8, and the codebook subset configuration includes one or more allowed codebook subsets and antenna group information.

In some implementations of the second aspect of the present disclosure, the first field includes an SRS resource indicator field.

In some implementations of the second aspect of the present disclosure, the second field is associated with precoding information and a number of layers.

According to a third aspect of the present disclosure, a Base Station (BS) is provided. The BS includes at least one processor and at least one non-transitory computer-readable medium coupled to the at least one processor. The at least one non-transitory computer-readable medium stores one or more computer-executable instructions that, when executed by the at least one processor, cause the BS to transmit a Radio Resource Control (RRC) message to a User Equipment (UE), the RRC message including a Physical Uplink Shared Channel (PUSCH) configuration; and transmit a Downlink Control Information (DCI) format to the UE to enable the UE to determine a precoding matrix based on the DCI format and the PUSCH configuration and perform a codebook-based PUSCH transmission using the precoding matrix, where the DCI format includes at least one of: a first field that indicates an 8-port Sounding Reference Signal (SRS) resource, a second field that includes an index associated with a precoding matrix transmission, a third field that indicates a first set of parameters for transmitting a first codeword, and a fourth field that indicates a second set of parameters for transmitting a second codeword.

In some implementations of the third aspect of the present disclosure, the first set of parameters includes a first Modulation and Coding Scheme (MCS) associated with the first codeword, a first New Data Indicator (NDI) associated with the first codeword, and a first Redundancy Version (RV) associated with the first codeword, and the second set of parameters includes a second MCS associated with the second codeword, a second NDI associated with the second codeword, and a second RV associated with the second codeword.

In some implementations of the third aspect of the present disclosure, the PUSCH configuration includes a PUSCH-Config Information Element (IE) that includes a txConfig field set to a value of ‘codebook.’

In some implementations of the third aspect of the present disclosure, the PUSCH configuration includes a PUSCH-Config Information Element (IE) that includes information associated with a number of maximum transmission ranks, a transform precoding configuration, and a codebook subset configuration.

In some implementations of the third aspect of the present disclosure, the number of maximum transmission ranks is one of 1, 2, 4, and 8, and the codebook subset configuration includes one or more allowed codebook subsets and antenna group information.

In some implementations of the third aspect of the present disclosure, the first field includes an SRS resource indicator field.

In some implementations of the third aspect of the present disclosure, the second field is associated with precoding information and a number of layers.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart of a method/process for UL transmission enhancement, according to an example implementation of the present disclosure.

FIG. 2 is a flowchart of a method/process for UL transmission enhancement, according to an example implementation of the present disclosure.

FIG. 3 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| 5GC | 5G Core |
| ACK | Acknowledgement |
| AN-PDB | Access Network Packet Delay Budget |
| AS | Access Stratum |
| ASN.1 | Abstract Syntax Notation One |
| BFRQ | Beam Failure Recovery Request |
| BS | Base Station |
| BSR | Buffer Status Report |
| BWP | Bandwidth Part |
| C-RNTI | Cell Radio Network Temporary Identifier |
| CA | Carrier Aggregation |
| CAG | Closed Access Group |
| CB | Codebook-Based |
| CG | Configured Grant |
| CJT | Coherent Joint Transmission |
| CN | Core Network |
| CN-PDB | Core Network Packet Delay Budget |
| CORESET | Control Resource Set |
| CPE | Customer Premises Equipment |
| CRC | Cyclic Redundancy Check |
| CSI | Channel State Information |
| CSI-RS | Channel State Information Reference Signal |
| CS-RNTI | Configured Scheduling Radio Network Temporary |
| | Identifier |
| CSS | Common Search Space |
| CU | Central Unit |
| DAPS | Dual Active Protocol Stack |
| DC | Dual Connectivity |
| DCI | Downlink Control Information |
| DG | Dynamic Grant |
| DI | Delay Information |
| DL | Downlink |
| DL-SCH | Downlink Shared Channel |
| DMRS | Demodulation Reference Signal |
| DR | Delay Report |
| DRB | Data Radio Bearer |
| DTCH | Dedicated Traffic Channel |
| DU | Distributed Unit |
| ETSI | European Telecommunications Standards Institute |
| E-UTRA | Evolved Universal Terrestrial Radio Access |
| EN-DC | E-UTRA NR Dual Connectivity |
| EPC | Evolved Packet Core |
| eMBB | Enhanced Mobile BroadBand |
| eMTC | Enhanced Machine Type Communication |
| eNB | Evolved Node B |
| FDD | Frequency Division Duplexing |
| FR | Frequency Range |
| FR1 | Frequency Range 1 |
| FR2 | Frequency Range 2 |
| FWA | Fixed Wireless Access |
| GEO | Geostationary Equatorial Orbit |
| gNB | Next Generation Node B |
| GNSS | Global Navigation Satellite System |
| GW | Gateway |
| HARQ | Hybrid Automatic Repeat Request |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| ITU | International Telecommunication Union |
| L1 | Layer 1 |
| L2 | Layer 2 |
| L3 | Layer 3 |
| LAN | Local Area Network |
| LCH | Logical Channel |
| LCID | Logical Channel Identity |
| LEO | Low Earth Orbit |
| LTE | Long Term Evolution |
| MAC | Medium Access Control |
| MAC CE | MAC Control Element |
| MCG | Master Cell Group |
| MCS | Modulation Coding Scheme |
| MIB | Master Information Block |
| MIMO | Multi-Input Multi-Output |
| mMTC | Massive Machine Type Communications |
| MN | Master Node |
| MTC | Machine Type Communication |
| NACK | Negative Acknowledgement |
| NAS | Non-Access Stratum |
| NB-IoT | Narrow Band Internet of Things |
| NCB | Non-Codebook-Based |
| NDI | New Data Indicator |
| NPN | Non-Public Network |
| NR | New Radio |
| NR-U | NR Unlicensed |
| NTN | Non-Terrestrial Network |
| PBCH | Physical Broadcast Channel |
| PCell | Primary Cell |
| PCI | Physical Cell Identity |
| PDB | Packet Delay Budget |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical |
| PLMN | Public Land Mobile Network |
| PNI-NPN | Public Network Integrated Non-Public Network |
| PRACH | Physical Random Access Channel |
| PSDB | PDU Set Delay Budget |
| PUCCH | Physical Uplink Control Channel |
| PUSCH | Physical Uplink Shared Channel |
| QCL | Quasi-CoLocation |
| QoS | Quality of Service |
| RA | Random Access |
| RACH | Random Access Channel |
| RAN | Radio Access Network |
| RAR | Random Access Response |
| RAT | Radio Access Technology |
| Rel-15 | Release 15 |
| RF | Radio Frequency |
| RLC | Radio Link Control |
| RS | Reference Signal |
| RLF | Radio Link Failure |
| RSTD | Reference Signal Time Difference Measurement |
| RNTI | Radio Network Temporary Identifier |
| RO | RACH Occasion |
| RRC | Radio Resource Control |
| RS | Reference Signal |
| RSRP | Reference Signal Received Power |
| RSRQ | Reference Signal Receiving Quality |
| RX | Reception |
| SCell | Secondary Cell |
| SCG | Secondary Cell Group |
| SDT | Small Data Transmission |
| SI | System Information |
| SIB | System Information Block |
| SL | Sidelink |
| SLIV | Start and Length Indicator Value |
| SN | Secondary Node |
| SNPN | Stand-alone Non-Public Network |
| SpCell | Special Cell |
| SR | Scheduling Request |
| SRB | Signaling Radio Bearer |
| SRS | Sounding Reference Signal |
| SRI | SRS Resource Indicator |
| SSB | Synchronization Signal Block |
| SUL | Supplementary Uplink |
| TA | Timing Advance |
| TAG | Timing Advance Group |
| TAT | Time Alignment Timer |
| TB | Transport Block |
| TCI | Transmission Configuration Indication |
| TDD | Time Division Duplexing |
| TN | Terrestrial Network |
| TPC | Transmission Power Control |
| TPMI | Transmit Precoder Matrix Indication |
| TRP | Transmission Reception Point |
| TRS | Tracking Reference Signal |
| TS | Technical Specification |
| TX | Transmission |
| UCI | Uplink Control Information |
| UE | User Equipment |
| UL | Uplink |
| UL-CG | Uplink-Configured Grant |
| UPF | User Plane Function |
| URLLC | Ultra-Reliable and Low-Latency Communications |
| USIM | Universal Subscriber Identity Module |
| USS | UE-specific Search Space |
| V2X | Vehicle-to-Everything |
| VSAT | Very Small Aperture Terminal |
| XR | Extended Reality |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, or at least one of A and B.

The terms, definitions, and abbreviations included in the present disclosure are either sourced from existing documents (such as those from ETSI, ITU, or other sources) or newly created by experts from the 3GPP whenever there was a need for precise vocabulary.

Examples of some selected terms in the present disclosure are provided as follows.

Antenna Panel: a conceptual term for a UE antenna implementation. It may be assumed that a panel is an operational unit for controlling a transmit spatial filter (beam). A panel may typically include a plurality of antenna elements. In one implementation, a beam may be formed by a panel, and in order to form two beams simultaneously, two panels may be needed. Such simultaneous beamforming from multiple panels may be subject to UE capability. A similar definition for “panel” may be applicable by applying spatial receiving filtering characteristics.

Beam: the term “beam” may be replaced by spatial filter in the present disclosure. For example, when a UE reports a preferred gNB TX beam, the UE may select a spatial filter used by the gNB. The term “beam information” may be used to provide information about which beam/spatial filter is being used/selected. In one implementation, individual reference signals may be transmitted by applying individual beams (spatial filters). Thus, the term “beam” or “beam information” may be represented by reference signal resource index(es).

DCI: DCI may refer to downlink control information, and there may be various DCI formats used in a PDCCH. The DCI format may be a predefined format in which the downlink control information may be packed/formed and transmitted in a PDCCH.

TCI state: a TCI state may include parameters for configuring a QCL relationship between one or more DL reference signals and a target reference signal set. For example, a target reference signal set may be the DMRS ports of a PDSCH or a PDCCH.

HARQ: A functionality that ensures delivery between peer entities at Layer 1 (e.g., the Physical Layer). A single HARQ process may support one TB when the physical layer is not configured for DL/UL spatial multiplexing. When the physical layer is configured for DL/UL spatial multiplexing, a single HARQ process may support one or more TBs. There may be one HARQ entity per serving cell. Each HARQ entity may support a parallel number of DL and UL HARQ processes.

MIMO is one of the key technologies in NR systems and has been successful in the commercial deployments. In the past recent years, MIMO features have been investigated and specified for both FDD and TDD systems, with major focus on the DL MIMO operations. For now, it may be important to identify and specify necessary enhancements for the UL MIMO, while necessary enhancements on the DL MIMO that facilitate the use of a large antenna array, not only for FR1, but also for FR2, may still need to be developed to fulfill the requests for the evolution of the NR deployments.

For example, enhancements for the UL DMRS, SRS, SRI, and TPMI (including the codebook) may be specified to enable an 8TX UL operation to support four or more layers per UE in the UL targeting CPE/FWA/vehicle/industrial devices. Potential restrictions on this objective (including coherence assumption of full/non-full power modes) may be identified. Moreover, the 8TX UL operation may refer to a UE that has eight antenna ports for the UL transmissions.

MIMO technology is an effective way to increase the throughput of the NR systems. One of the key features of the MIMO technology may be beamforming. Beamforming may be achieved by using a precoder in a multi-antenna system (e.g., analog beamforming, digital beamforming, and/or hybrid beamforming). Determining such a precoder, however, may be a practical problem in the NR system, involving resource allocation (e.g., the SRS resource allocation), indication signaling (e.g., the SRI and the TPMI), etc. Based on the hardware improvements, a UL MIMO operation supporting up to 8TX transmissions may be possible and then lead to the improved system throughput. To support the 8TX UL transmission, some enhanced mechanisms may need to be established, such as the UE capability reporting (e.g., the maximum number of antenna ports may be up to eight), SRS configurations (e.g., the SRS configuration(s) may support a UL CB transmission with an 8TX UE), PUSCH configurations (e.g., a UL MIMO operation may support a UE with 8TX), PUSCH transmissions (e.g., enhanced precoder indications and support for dual codewords), etc. Therefore, different mechanisms are proposed in the present disclosure to address the problems related to indicating precoders in an 8TX UL transmission. The proposed mechanisms for an 8TX CB/NCB PUSCH transmission may include enhancements to the UE capability, the support for dual-codeword transmission, and/or the precoding matrix indication. The present disclosure further elaborates on the aforementioned aspects, including the UE capability reporting, SRS configurations, PUSCH configurations, and PUSCH transmissions.

Moreover, in the present disclosure, the terms “an antenna port” and “antenna ports” may refer to “an antenna port used for the transmission of PUSCH(s)/PUCCH(s)” and “antenna ports used for the transmission of PUSCH(s)/PUCCH(s),” respectively. The symbol p may represent the number of antenna ports of the UE. For example, if the UE is equipped with eight antenna ports (8TX), then p may be equal to eight. A fully coherent/partially coherent/noncoherent codebook (subset) may include one or more transmit precoding matrices. A fully coherent codebook subset may imply that all precoders in the corresponding codebook subset are fully coherent. A partially coherent codebook subset may imply that all precoders in the corresponding codebook subset are partially coherent. A noncoherent codebook subset may imply that all precoders in the corresponding codebook subset are noncoherent. An SRS-port may refer to an antenna port used for transmitting the SRS. A Rel-15 4TX codebook may refer to the codebooks used for a UL CB transmission when the UE is equipped with four antenna ports. A Rel-15 2TX codebook may refer to the codebooks used for a UL CB transmission when the UE is equipped with two antenna ports.

In the present disclosure, although the term “gNB” is used throughout the document, it should be understood that the term “gNB” can be replaced by any other type of BS.

### UE Capability Reporting

A UE may report its UE capability to the gNB/NW by sending a UE capability information (or UECapabilityInformation) message (e.g., via RRC signaling) when the UE receives a UE capability enquiry (e.g., a UECapabiiityEnquiry) message (e.g., via RRC signaling) from the gNB/NW. The UECapabilityInformation message may include, indicate, and/or be associated with at least one of the following: (1) the maximum number of transmission layers for a CB PUSCH, (2) the maximum number of SRS resources for a CB PUSCH per SRS resource set, (3) the maximum number of simultaneous transmitted SRS resources for a CB PUSCH, (4) the maximum number of SRS resources for an NCB PUSCH per SRS resource set, (5) the maximum number of transmitted layers for NCB PUSCH, (6) the maximum number of simultaneous transmitted SRS resources for an NCB PUSCH, (7) the codebook subset support capability, (8) the antenna port information (e.g., the number of antenna groups and/or the layout configuration), and (9) the maximum number of codewords.

In some implementations, the UE may use a particular field, such as the maxNumberMIMO-LayersCB-PUSCH field, in a particular IE, such as the FeatureSetUplinkPerCC IE, to inform the NW of the maximum number of transmission layers for a CB PUSCH. In some implementations, the UE may use a particular field, such as the maxNumberMIMO-LayersNCB-PUSCH field, in a particular IE, such as the FeatureSetUplinkPerCC IE, to inform the NW of the maximum number of transmission layers for an NCB PUSCH. In some implementations, the UE may use a particular field, such as the maxNumberSRS-ResourcePerSet field, in a particular IE, such as the FeatureSetUplinkPerCC IE, to inform the NW of the maximum number of SRS resources for a CB PUSCH per SRS resource set. In some implementations, the UE may use a particular field, such as the maxNumberSimultaneousSRS-ResourceTx field, in a particular IE, such as the FeatureSetUplinkPerCC IE, to inform the NW of the maximum number of simultaneous transmitted SRS resources for a CB PUSCH.

In some implementations, the UE may use a field in a particular IE, such as the FeatureSetUplinkPerCC IE, to inform the NW of the maximum number of SRS resources for a CB PUSCH per SRS resource set. In some implementations, the UE may use a particular field, such as the maxNumberSimultaneousSRS-ResourceTx field, in the FeatureSetUplinkPerCC IE to inform the NW of the maximum number of simultaneous transmitted SRS resources for an NCB PUSCH. In some implementations, the UE may use a particular field, such as the pusch-TransCoherence field, in a particular IE, such as the MIMO-ParametersPerBand IE, to inform the NW of the codebook subset support capability. In some implementations, the UE may use one or more fields in a particular IE to inform the NW of the antenna port information. In some implementations, the UE may use a field in a particular IE to inform the NW of the maximum number of codewords.

In some implementations, after a gNB/NW sends the UECapabiiityEnquiry message to a UE, the UE may report the maximum number of transmission layers for a CB PUSCH from one layer to v layers by sending the UECapabilityInformation message (e.g., that includes the maxNumberMIMO-LayersCB-PUSCH field) to the gNB/NW based on the UE capability, where the UE may have eight antenna ports and v∈{1,2, . . . , c} such that v may be one, an odd number, or an even number. In some implementations, c may be chosen as one or an even numbers within the sequence {1, . . . , ρ}, where c may be limited by ρ. For example, if the UE has only four antenna ports, ρ is equal to four, and then the maximum number of c is four. Therefore, the maximum number of transmission layers may be four. In other words, the maximum number of transmission layers may be up to eight when the UE is equipped with eight antenna ports. The number of layers indicated for the actual transmission may be limited to a number less than or equal to the maximum number of transmission layers.

In some implementations, after a gNB/NW sends the UECapabiiityEnquiry message to a UE, the UE may report the maximum number of transmission layers for an NCB PUSCH from one layer to v layers by sending the UECapabilityInformation message (e.g., which includes the maxNumberMIMO-LayersNCB-PUSCH field) based on the UE capability, where the UE may have eight antenna ports and v∈{1, . . . , c} such that v is one, an odd number, or an even number. In some implementations, c may be chosen as one or an even number within the sequence {1, . . . , ρ}. The number of layers indicated for the actual transmission may be limited to a number less than or equal to the maximum number of transmission layers. Moreover, the maximum number of transmission layers may be up to eight when the UE is equipped with eight antenna ports.

In some implementations, after a gNB/NW sends the UECapabiiityEnquiry message to a UE, the UE may respond to the gNB/NW by sending the UECapabilityInformation message, where the UECapabilityInformation message may include information on the maximum number of SRS resources for a CB PUSCH per SRS resource set. For example, the maxNumberSRS-ResourcePerSet field in the UECapabilityInformation message may indicate a number from one to c, where c may be two, three, or four. The ULE may have eight antenna ports. For example, the maxNumberSRS-ResourcePerSet field may be in a format of INTEGER, e.g., INTEGER (1 . . . 4}, INTEGER (1 . . . 2), INTEGER (1 . . . 3}. If the UE indicates that the maxNumberSRS-ResourcePerSet field is 4, it means that the maximum number of SRS resources supported by the UE for a CB PUSCH per SRS resource set is 4.

In some implementations, after a gNB/NW sends the UECapabiiityEnquiry message to a UE, the UE may respond to the gNB/NW by sending the UECapabilityInformation message, where the UECapabilityInformation message may include information on the maximum number of SRS resources for ab NCB PUSCH per SRS resource set. For example, the maxNumberSRS-ResourcePerSet field in the UECapabilityInformation message may indicate a number from one to c, where c may be four, five, six, seven, or eight. The UE may have eight antenna ports. For example, the maxNumberSRS-ResourcePerSet field may be in a format of INTEGER, e.g., INTEGER (1 . . . 4), INTEGER (1 . . . 5), INTEGER (1 . . . 6), INTEGER (1 . . . 7), INTEGER (1 . . . 8). If the UE indicates that the maxNumberSRS-ResourcePerSet field is 4, it means that the maximum number of SRS resources supported by the UE for an NCB PUSCH per SRS resource set is 8.

In some implementations, when a gNB/NW sends the UECapabiiityEnquiry message to a UE, the UE may respond to the gNB/NW by sending the UECapabilityInformation message, where the UECapabilityInformation message may include information on the maximum number of simultaneous transmitted SRS resources for a CB PUSCH. Moreover, such a maximum number may refer to the maximum number of simultaneous transmitted SRS resources in one symbol for a CB transmission to the UE. However, as the number of indicated SRS resources per SRS resource set increases, realizing all the SRS resources transmitted simultaneously in one symbol may become challenging, which may limit the maximum number of simultaneously transmitted SRS resources. Therefore, the maxNumberSimultaneousSRS-ResourceTx field in the FeatureSetUplinkPerCC IE may limit this number based on the UE capability. For example, the maxNumberSimultaneousSRS-ResourceTx field may indicate a number from one to c, where c may be associated with the maximum number of SRS resources for a CB PUSCH per SRS resource set. It should be noted that, unless otherwise specified in this disclosure, the UE mentioned herein is assumed to have eight antenna ports.

In some implementations, when a gNB/NW sends the UECapabilityEnquiry message to a UE, the UE may respond to the gNB/NW by sending the UECapabilityInformation message, where the UECapabilityInformation message may include information on the maximum number of simultaneous transmitted SRS resources for an NCB PUSCH. Moreover, such a maximum number may refer to the maximum number of simultaneous transmitted SRS resources in one symbol for an NCB transmission to the UE. As the number of indicated SRS resources per SRS resource set increases, realizing all the SRS resources transmitted simultaneously in one symbol may become challenging, which may limit the maximum number of simultaneously transmitted SRS resources. Thus, the maxNumberSimultaneousSRS-ResourceTx field in the FeatureSetUplinkPerCC IE may limit this number based on the UE capability. For example, the maxNumberSimultaneousSRS-ResourceTx field may indicate a number from one to c, where c may be associated with the maximum number of SRS resources for an NCB PUSCH per SRS resource set.

In some implementations, when a gNB/NW sends the UECapabilityEnquiry message to a UE, the UE may respond to the gNB/NW by sending the UECapabilityInformation message, where the UECapabilityInformation message may include antenna port information. For example, the number of antenna groups (e.g., Ng) may be indicated by one of the fields within the FeatureSetUplinkPerCC IE, the MIMO-ParametersPerBand IE, and/or another IE as part of the UECapabilityInformation message.

Additionally, the UE may have multiple antenna ports that are fully coherent, partially coherent, or noncoherent within the same antenna group. Furthermore, each antenna group may be coherent or noncoherent in connection with another antenna group. In some implementations, if the field indicating the number of antenna groups is absent, the gNB/NW may consider that all antenna ports of the UE are in one antenna group. In some implementations, if the number of antenna ports used for a UL transmission is more than four, the UE may report the number of antenna groups as two or four to the gNB/NW based on the UE capability. For example, the layout information of antenna elements may be indicated by another field within the FeatureSetUplinkPerCC IE, the MIMO-ParametersPerBand IE, and/or another IE as part of the UECapabilityInformation message.

The layout information may refer to the spatial distribution of antenna elements on the UE's antenna panel, where each dual-polarized antenna element pair may be associated with, or may be connected to, two antenna ports. In addition, the layout information may be a pair of parameters (e.g., (N₁, N₂)), where Nᵢ may refer to the number of antenna elements in a first dimension and N₂ may refer to the number of antenna elements in a second dimension. In some implementations, if this field is absent, the gNB/NW may consider the layout information as a default configuration. In some implementations, if the number of antenna ports used for a UL transmission is more than four, the UE may report the pair of parameters (N₁, N₂) as (4,1) or (2,2) to the gNB/NW, based on the UE capability. In some implementations, if the number of antenna ports used for a UL transmission is more than four, the UE may report to the gNB/NW that both (N₁, N₂)=(4,1) and (N₁, N₂)=(2,2) are applicable. The UE may have eight antenna ports.

In some implementations, when a gNB/NW sends the UECapabiiityEnquiry message to a UE, the UE may respond to the gNB/NW by sending the UECapabilityInformation message, where the UECapabilityInformation message may include the antenna port information. In some implementations, the antenna port information may include the number of antenna groups and the layout information. For one antenna group, the UE may have multiple antenna ports that are fully coherent, partially coherent, or noncoherent within the same antenna group, and each antenna group itself may be coherent or noncoherent in relation to another antenna group. For a layout configuration, the UE may indicate a particular spatial distribution of antenna elements on the antenna panel of the UE, where each dual-polarized antenna element pair may be associated with (or be connected to) two antenna ports. The number of antenna groups may be denoted as N_{g}, and the layout information may be represented by a pair of parameters (N₁, N₂), where N₁ refers to the number of antenna elements in a first dimension and N₂ refers to the number of antenna elements in a second dimension.

The UE may report two pieces of information (e.g., the antenna port information and the layout information) in a single field within the FeatureSetUplinkPerCC IE, the MIMO-ParametersPerBand IE, and/or another IE, as part of the UECapabilityInformation message. For example, the UE may indicate a set of parameters (N_{g}, N₁, N₂) to the gNB/NW by sending the UECapabilityInformation message. The set of parameters may be represented as a single field within the corresponding IE. In some implementations, if this field is absent from the IE, the gNB/NW may consider the antenna port information as a default configuration. For example, if the UE is equipped with four antenna ports, this field may be absent because only one type of layout may exist. In another example, if the UE is equipped with eight antenna ports and this field is absent, the gNB/NW may consider the default antenna port information, and the default antenna port information may refer to (N_{g}, N₁, N₂)=(2,4,1), (4,4,1), (2,2,2), or (4,2,2).

In some implementations, if the number of antenna ports used for a UL transmission is more than four, the UE may report (N_{g}, N₁, N₂)=(2,4,1), (4,4,1), (2,2,2), or (4,2,2) to the gNB/NW, based on the UE capability. In some implementations, if the number of antenna ports used for a UL transmission is more than four, the UE may report to the gNB/NW that both (N_{g}, N₁, N₂)=(2,4,1) and (N_{g}, N₁, N₂)=(2,2,2) are applicable. In some implementations, if the number of antenna ports used for a UL transmission is more than four, the UE may report to the gNB/NW that both (N_{g}, N₁, N₂)=(4,4,1) and (N_{g}, N₁, N₂)=(4,2,2) are applicable.

In some implementations, when a gNB/NW sends the UECapabilityEnquiry message to a UE, the UE may respond to the gNB/NW by sending the UECapabilityInformation message, where the UECapabilityEnquiry message may indicate a codebook subset support capability. The codebook subset support capability may refer to the characteristics of the supported codebook subset used for a CB PUSCH transmission. The UE may report the codebook subset support capability by sending the UECapabilityInformation message (e.g., which includes the pusch-TransCoherence field within the MIMO-ParametersPerBand IE) to the gNB/NW. For example, the UE may set the pusch-TransCoherence field to one of three possible settings: fullCoherent, partialCoherent, and noncoherent. If the UE configures the pusch-TransCoherence field to fullCoherent, it may imply that the UE may support the fully coherent, partially coherent, and noncoherent codebook subsets. If the UE configures the pusch-TransCoherence field to partialCoherent, it may imply that the UE may support the partially coherent and noncoherent codebook subsets. If the UE configures the pusch-TransCoherence field to noncoherent, it may imply that the UE may only support the noncoherent codebook subsets. In addition, the setting of the pusch-TransCoherence field may restrict a particular parameter, such as codebooksubset, in the PUSCH-Config IE configured by the gNB/NW.

In some implementations, when a gNB/NW sends the UECapabilityEnquiry message to a UE, the UE may respond to the gNB/NW by sending the UECapabilityInformation message, where the UECapabilityEnquiry message may indicate a codebook subset support capability and the number of antenna groups. The codebook subset support capability may refer to the characteristics of the supported codebook subset used for a CB PUSCH transmission. In addition, the UE may have antenna ports that are fully coherent, partially coherent, or noncoherent within the same antenna group, and each antenna group itself may be coherent or noncoherent in relation to another antenna group. The UE may report both the codebook subset support capability and the number of antenna groups in a single field within the FeatureSetUplinkPerCC IE, the MIMO-ParametersPerBand IE, and/or another IE by sending the UECapabilityInformation message to the gNB/NW, where this IE may be included in the UECapabilityInformation message. For example, the UE may set this field to one of five possible settings: Ng4-fullCoherent, N_{g}4-partialCoherent, Ng2-fullCoherent, N_{g}2-partialCoherent, or noncoherent. For example, this field may be in an ENUMERATED format, such as ENUMERATED{Ng4-fullCoherent, Ng4-partialCoherent, Ng2-fullCoherent, Ng2-partialCoherent, noncoherent}, or ENUMERATED{Ng4-fullCoherent, Ng4-partialCoherent, Ng2-fullCoherent, Ng2-partialCoherent, noncoherent, spare1, spare2, spare3}.

If the UE configures this field to Ng4-fullCoherent, it may imply that the UE may support the fully coherent, partially coherent, and noncoherent codebook subsets and that the number of antenna groups is equal to four. If the UE configures this field to Ng4-partialCoherent, it may imply that the UE may support the partially coherent and noncoherent codebook subsets and that the number of antenna groups is equal to four. If the UE configures this field to Ng2-fullCoherent, it may imply that the UE may support the fully coherent, partially coherent, and noncoherent codebook subsets and that the number of antenna groups is equal to two. If the UE configures this field to Ng2-partialCoherent, it may imply that the UE may support the partially coherent and noncoherent codebook subsets and that the number of antenna groups is equal to two. If the UE configures this field to noncoherent, it may imply that the UE may only support the noncoherent codebook subsets. In addition, the setting of this field may restrict the parameter codebooksubset within the PUSCH-Config IE configured by the gNB/NW.

In some implementations, when a gNB/NW sends the UECapabilityEnquiry message to a UE, the UE may respond to the gNB/NW by sending the UECapabilityInformation message, where the UECapabilityInformation message may indicate the maximum number of codewords. The number of codewords may be used to determine a trade-off between the signaling overhead for the HARQ acknowledgment and the amount of data that needs to be re-transmitted in a case of a codeword error. The UE may report the maximum number of codewords by sending the UECapabilityInformation message (e.g., which includes a single field within the FeatureSetUplinkPerCC IE, the MIMO-ParametersPerBand IE, and/or another IE) to the gNB/NW. For example, the UE may set this field to one of two possible settings: n1 and n2.

The field may be in an ENUMERATED format such as ENUMERATED{n1, n2}. If the UE configures this field to n1, it may imply that the UE may only support the single codeword transmission. If the UE configures this field to n2, it may imply that the UE may support both the single codeword transmission and the dual codewords transmission. In some implementations, if this field is set to n1, a single codeword may be mapped to all the transmission layers for a CB/NCB PUSCH. In some implementations, if this field is set to n2, the number of enabled codewords may be determined based on the number of transmission layers. For example, if the number of transmission layers configured by the gNB/NW is less than four, only one codeword may be enabled; otherwise, two codewords may be enabled. In some implementations, if this field is set to n2 and only one codeword is enabled, a single codeword may be mapped to all the transmission layers for a CB/NCB PUSCH. In some implementations, if this field is set to n2 and two codewords are enabled, each codeword may be mapped to a corresponding transmission layer group for a CB/NCB PUSCH.

### SRS Configurations

A UE may be configured with one or more SRS configurations after receiving a particular RRC message(s) from the gNB/NW, such as an RRC setup (or RRCSetup) message, an RRC resume (or RRCResume) message, an RRC reconfiguration (or RRCReconfiguration) message, and/or another RRC message sent by the gNB/NW. These RRC messages may include a particular IE, such as the SRS-Config IE, which is associated with the parameter settings of the SRS resources and the SRS resource sets. An SRS may refer to a particular type of reference signal used by the gNB/NW to estimate the UL channel quality. The SRS triggering mechanism may be categorized into three types: triggered by DCI (aperiodic SRS), triggered by a MAC CE (semi-persistent SRS), and triggered by RRC signaling (periodic SRS). The gNB/NW may use a particular field, such as the resourceType field, within another particular field, such as the SRS-ResourceSet field, to configure the triggering mechanism to the UE. The SRS-ResourceSet field may be included in the SRS-Config IE, where the SRS-Config IE may be carried by the RRCSetup message, the RRCResume message, the RRCReconfiguration message, and/or another RRC message.

For example, if the field resourceType is set to aperiodic, the SRS associated with the corresponding SRS resource set may be transmitted aperiodically in response to the UE receiving the DCI signaling (e.g., DCI format 0_1/0_2) that includes a non-zero value in the SRS request field. If the resourceType field is set to semi-persistent, the SRS associated with the corresponding SRS resource set may be transmitted semi-persistently in response to the UE receiving the corresponding MAC CE. If the resourceType field is set to periodic, the SRS associated with the corresponding SRS resource set may be transmitted periodically without any further triggering after the UE receives the corresponding (RRC) configuration.

In some implementations, if the UE receives the SRS-Config IE with the SRS-ResourceSet field from the gNB/NW and the usage field within the SRS-ResourceSet field is set to ‘codebook,’ the number of SRS ports for the SRS resource may be configured in the corresponding nrofSRS-ports field of the SRS-Resource field of the SRS-ResourceSet field. The number of SRS-ports for the SRS resource may be configured as one, two, four, or eight. The maximum number of configured SRS-ports per SRS resource may be limited by the maxNumberSRS-Ports-PerResource field in the UECapabilityInformation message sent by the UE.

In some implementations, if a UE receives the SRS-Config IE with the SRS-ResourceSet field from the gNB/NW and the usage field within the SRS-ResourceSet field is set to ‘noncodebook,’ the number of SRS ports for the SRS resource may be configured in the corresponding nrofSRS-ports field of the SRS-Resource field of the SRS-ResourceSet field. Each SRS resource in the corresponding SRS resource set may be configured with only one SRS-port.

In some implementations, if a UE receives the SRS-Config IE with the SRS-ResourceSet field from the gNB/NW, then the SRS resources of each SRS resource set for the UE may be configured in a particular field, such as the srs-ResourceToAddModList field, in the SRS-Config IE. If the usage field of the SRS-ResourceSet field is set to ‘codebook,’ the number of configured SRS resources in an SRS resource set for the UE may be less than or equal to the value indicated by the maxNumberSRS-ResourcePerSet field in the mimo-CB-PUSCH field within the FeatureSetUplinkPerCC IE. Additionally, the number of SRS ports for each configured SRS resource in an SRS resource set may be identical or different.

In some implementations, if a UE receives the SRS-Config IE with the SRS-ResourceSet field from the gNB/NW, then the SRS resources of each SRS resource set for the UE may be configured in the srs-ResourceToAddModList field in the SRS-Config IE. If the usage field of the SRS-ResourceSet field is set to ‘noncodebook,’ the number of configured SRS resources in an SRS resource set for the UE may be less than or equal to the value indicated by the maxNumberSRS-ResourcePerSet field in the mimo-NCB-PUSCH field within the FeatureSetUplinkPerCC IE.

In some implementations, if the UE receives the SRS-Config IE from the gNB/NW, then each SRS resource set for the UE may be configured in the srs-ResourceSetToAddModListDCI field or the srs-ResourceSetToAddModListDCI-0-2-r16 field in the SRS-Config IE. The maximum number of the configured SRS resource sets for the UE may be less than or equal to a particular number, such as maxNrofSRS-ResourceSets, where the number maxNrofSRS-ResourceSets may be equal to 16. In some implementations, if the higher layer parameter, such as usage, in the SRS-ResourceSet field, is set to ‘codebook,’ one or two SRS resource sets may be configured in the srs-ResourceSetToAddModList filed or the srs-ResourceSetToAddModListDCI-0-2-r16 field.

In some implementations, if the UE is configured with two SRS resource sets by the gNB/NW and the higher layer parameter usage in the SRS-ResourceSet field is set to ‘codebook,’ the number of the configured SRS resources in each SRS resource set may be identical.

In some implementations, if the UE is configured with two SRS resource sets by the gNB/NW and the higher layer parameter usage in the SRS-ResourceSet field is set to ‘codebook,’ the number of the configured SRS resources in each SRS resource set may be different.

In some implementations, if the UE receives the SRS-Config IE from the gNB/NW, each SRS resource set for the UE may be configured in the field srs-ResourceSetToAddModListDCI or the field srs-ResourceSetToAddModListDCI-0-2-r16 in the SRS-Config IE. The maximum number of the configured SRS resource sets for the UE may be less than or equal to the number maxNrofSRS-ResourceSets where the number maxNrofSRS-ResourceSets may be equal to 16. In some implementations, if the higher layer parameter usage in the SRS-ResourceSet field is set to ‘noncodebook,’ one or two SRS resource sets may be configured in the srs-ResourceSetToAddModList field or the srs-ResourceSetToAddModListDCI-0-2-r16 field.

In some implementations, if the UE is configured with two SRS resource sets by the gNB/NW and the higher layer parameter usage in the SRS-ResourceSet field is set to ‘noncodebook,’ the number of the configured SRS resources in each SRS resource set may be identical.

In some implementations, if the UE is configured with two SRS resource sets by the gNB/NW and the higher layer parameter usage in the SRS-ResourceSet field is set to ‘noncodebook,’ the number of the configured SRS resources in each SRS resource set may be different.

### PUSCH Configurations

A UE may be configured with one or more PUSCH configurations after receiving one or more RRC messages, such as an RRCSetup message, RRCResume message, RRCReconfiguration message, and/or another RRC message received from the gNB/NW. These RRC messages may include a PUSCH-Config IE, which may be associated with the parameter settings used for a PUSCH transmission. The PUSCH-Config IE may include at least one of the following fields: the txConfig field, the mcs-Table field, the mcs-TableTransformPrecoder field, the transformPrecoder field, the codebookSubset field, the codebookSubsetDCI-0-2-r16 field, the maxRank field, the maxRankDCI-0-2-r16 field, the mcs-TableDCI-0-2-r16 field, and the mcs-TableTransformPrecoderDCI-0-2-r16 field.

The txConfig field may be used to determine whether the UE uses a CB or NCB PUSCH transmission. For example, if the txConfig field is set to ‘codebook,’ the UE may perform a CB PUSCH transmission; if the txConfig field is set to ‘noncodebook,’ the UE may perform an NCB PUSCH transmission; if the txConfig field is absent, the UE may transmit a PUSCH using one antenna port.

The mcs-Table field or the mcs-TableTransformPrecoder field may be used to determine which MCS table is to be used for a PUSCH transmission triggered by the DCI format 0_0/DCI format 0_1 where the transform precoding is disabled/enabled.

The mcs-Table-DCI-0-2-r16 field or the mcs-TableTransformPrecoder-DCI-0-2-r16 field may be used to determine which MCS table is to be used for a PUSCH transmission triggered by the DCI format 0_2 where the transform precoding is disabled/enabled.

The maxRank field or the maxRankDCI-0-2-r16 field may be used to determine the maximum transmission rank for a PUSCH triggered by the DCI format 0_1/DCI format 0_2.

The codebookSubset field or the codebookSubsetDCI-0-2-r16 field may be used to determine the codebook subset(s) of TPMIs that may be used for a PUSCH triggered by the DCI format 0_1/DCI format 0_2.

The transformPrecoder field may be used to determine whether a transform precoding is enabled or disabled. If the transformPrecoder field is absent from the PUSCH-Config IE, the UE may apply the value of the msg3-transformPrecoder field.

In some implementations, if the UE receives the PUSCH-Config IE that includes the field maxRank from the gNB/NW via RRC signaling, the UE may configure the maximum transmission rank of a PUSCH for itself. The value of the field maxRank may be an integer between one and c. For example, the format of the field maxRank may be INTEGER(0 . . . c). Additionally, c may be less than or equal to the maxNumberMIMO-LayersCB-PUSCH/maxNumberMIMO-LayersNCB-PUSCH when txConfig is set to codebook/noncodebook.

In some implementations, if the UE receives the PUSCH-Config IE that includes the field codebookSubset from the gNB/NW via RRC signaling, the UE may configure the maximum coherence capabilities of the support codebook subset(s) for itself. For example, if the field codebookSubset is set to ‘fullyAndPartialAndNonCoherent,’ the support codebook subset(s) may include a full-coherent codebook, a partial-coherent codebook, and a noncoherent codebook; if the field codebookSubset is set to ‘partialAndNonCoherent,’ the support codebook subset(s) may include a partial-coherent codebook, and a noncoherent codebook; if the field codebookSubset is set to ‘nonCoherent,’ the support codebook subset(s) may only include one or more than one noncoherent codebook. Additionally, the field codebookSubset may be restricted by the pusch-TransCoherence field within the UECapabilityInformation message. The field codebookSubsetDCI-0-2-r16 may operate on the same principle as the field codebookSubset.

In some implementations, if the UE receives the PUSCH-Config IE that includes the field codebookSubset from the gNB/NW via RRC signaling, the UE may configure the maximum coherence capabilities of the support codebook subset(s) for itself. For example, if the field codebookSubset is set to ‘fullyCoherent,’ the support codebook subset(s) may include a full-coherent codebook; if the field codebookSubset is set to ‘partialCoherent,’ the support codebook subset(s) may include a partial-coherent codebook; if field codebookSubset is set to ‘nonCoherent,’ the support codebook subset(s) may only include one or more than one noncoherent codebook. Additionally, the field codebookSubset may be restricted by pusch-TransCoherence within UECapabilityInformation message. The field codebookSubsetDCI-0-2-r16 may operate on the same principle with the field codebookSubset.

In some implementations, if the ULE receives the PUSCH-Config IE that includes the field codebookSubset from the gNB/NW via RRC signaling, the UE may configure the maximum coherence capabilities of the support codebook subset(s) and the antenna group information for itself. For example, if the field codebookSubset is set to ‘fullyAndNg2_PartialAndNonCoherent,’ the support codebook subset(s) may include a full-coherent codebook, a partial-coherent codebook applied to the UE with two antenna groups, and a noncoherent codebook. For example, if the field codebookSubset is set to ‘fullyAndNg4_PartialAndNonCoherent,’ the support codebook subset(s) may include a full-coherent codebook, a partial-coherent codebook applied to the UE with four antenna groups, and a noncoherent codebook. For example, if the field codebookSubset is set to ‘ng2_PartialAndNonCoherent,’ the support codebook subset(s) may include a partial-coherent codebook applied to the UE with two antenna groups and a noncoherent codebook. For example, if the field codebookSubset is set to ‘ng4_PartialAndNonCoherent,’ the support codebook subset(s) may include a partial-coherent codebook applied to the UE with four antenna groups and a noncoherent codebook. For example, if the field codebookSubset is set to ‘nonCoherent,’ the support codebook subset(s) may only include a noncoherent codebook. The field codebookSubsetDCI-0-2-r16 may operate on the same principle as the field codebookSubset.

In some implementations, if the UE receives the PUSCH-Config IE that includes the field codebookSubset from the gNB/NW via RRC signaling, the UE may configure the maximum coherence capabilities of the support codebook subset(s) and the antenna group information for itself. For example, if the field codebookSubset is set to ‘fullyCoherent,’ the support codebook subset(s) may include a full-coherent codebook. For example, if the field codebookSubset is set to ‘ng2_PartialAndNonCoherent,’ the support codebook subset(s) may include a partial-coherent codebook applied to the UE with two antenna groups and a noncoherent codebook. For example, if the field codebookSubset is set to ‘ng4_PartialAndNonCoherent,’ the support codebook subset(s) may include a partial-coherent codebook applied to the UE with four antenna groups and a noncoherent codebook. For example, if the field codebookSubset is set to ‘nonCoherent,’ the support codebook subset(s) may only include one or more than one noncoherent codebook. The field codebookSubsetDCI-0-2-r16 may operate on the same principle as the field codebookSubset.

In some implementations, if the UE receives the PUSCH-Config IE that includes the field codebookSubset from the gNB/NW via RRC signaling, the UE may configure the maximum coherence capabilities of the support codebook subset(s) and the antenna group information for itself. For example, if the field codebookSubset is set to ‘fullyCoherent,’ the support codebook subset(s) may include a full-coherent codebook. For example, if the field codebookSubset is set to ‘ng2_PartialCoherent,’ the support codebook subset(s) may include a partial-coherent codebook applied to the UE with two antenna groups. For example, if the field codebookSubset is set to ‘ng4_PartialCoherent,’ the support codebook subset(s) may include a partial-coherent codebook applied to the UE with four antenna groups. For example, if the field codebookSubset is set to ‘nonCoherent,’ the support codebook subset(s) may only include one or more than one noncoherent codebook. The field codebookSubsetDCI-0-2-r16 may operate on the same principle with the field codebookSubset.

### PUSCH Transmissions

A UE may be scheduled to perform PUSCH transmissions after receiving RRC signaling and/or DCI signaling from a gNB/NW. The PUSCH transmission scheduling may have three types: dynamic grant, configured grant type I (CG type I), and configured grant type II (CG type II). Dynamic grant may be enabled for each PUSCH scheduled by the DCI signaling received from the gNB/NW. CG type I may be enabled for periodic PUSCHs scheduled by RRC signaling received from the gNB/NW, where the RRC signaling may include the ConfiguredGrantConfigure IE with the field rrc-ConfiguredUplinkGrant. CG type II may be enabled for periodic PUSCHs if the UE, which is configured with the ConfiguredGrantConfigure IE without the field rrc-ConfiguredUplinkGrant, receives a UL grant via the DCI signaling received from the gNB/NW. The parameters applied for a PUSCH transmission may be obtained from the ConfiguredGrantConfig IE, the PUSCH-Config IE, and/or DCI signaling (e.g., the DCI format 0_0, the DCI format 01, or the DCI format 0_2). The parameters applied for a PUSCH transmission may include at least one of the following: MCS table information, an MCS indication, a redundancy version indication, a new data indication, transform precoder information, SRS resource indication information, SRS resource set indication information, and information of precoding, and the number of layers indication.

In some implementations, if the UE is configured with a two-codeword transmission by the gNB/NW via RRC signaling and the PUSCH is dynamically scheduled by a DCI format received from the gNB/NW, the received DCI format may include two sets of parameters, with each set of parameters scheduling a respective codeword transmission. For example, each set of parameters may include an MCS, an NDI, and/or an RV for the corresponding codeword. The MCS may be an index used to determine the modulation and coding scheme for the corresponding codeword in a PUSCH transmission. The NDI may be an index that indicates whether the current transmission is a new transmission or a retransmission. The RV may be a value indicating the redundancy information, such as the redundancy version, to be applied to the PUSCH transmission. For example, the received DCI format may include a first set of parameters and a second set of parameters, where the first set of parameters may include a first MCS associated with a first codeword, a first NDI associated with the first codeword, and/or a first RV associated with the first codeword. The second set of parameters may include a second MCS associated with a second codeword, a second NDI associated with the second codeword, and a second RV associated with the second codeword. In some implementations, these sets of parameters may be configured according to the corresponding scenario for each codeword. It should be noted that the UE may have eight antenna ports.

In some implementations, if the higher layer parameters (e.g., RRC signaling) indicate that the two-codeword transmission is enabled and the MCS index and the RV value for one of the two TBs are set to specific values, the corresponding TB may be disabled by the DCI signaling. For example, a DCI format 0_1 may disable an enabled TB when its corresponding MCS index is 26 and the RV value is 1. In some implementations, if the first higher layer parameter indicates that the two-codeword transmission is enabled and the second higher layer parameter relates to a list of time-domain configurations for the timing of DL assignment to DL data, the TBs for all the scheduled PUSCHs with a specific MCS index and a specific RV value may be disabled by the DCI signaling. For example, if a two-codeword transmission is enabled for the UE and the UE is configured with the second higher layer parameter, the DCI format 0_1 may be used to disable the TBs of all the scheduled PUSCHs of the UE, where the TBs may be configured with an MCS index of 26 and an RV value of 1.

In some implementations, if the UE is configured with a two-codeword transmission by the gNB/NW via the RRC signaling and the PUSCH is scheduled based on the CG Type II in response to the UE receiving a DCI format from the gNB/NW, the received DCI format may include two sets of parameters for scheduling different codewords. Each set of parameters may include an MCS, an NDI, and/or an RV For example, the received DCI format may include a first set of parameters and a second set of parameters. The first set of parameters may include a first MCS, a first NDI, and/or a first RV, and the second set of parameters may include a second MCS, a second NDI, and/or a second RV. These sets of parameters may be configured according to the corresponding scenario for each codeword. It should be noted that the UE may have eight antenna ports.

In some implementations, if the UE is configured with a two-codeword transmission by the gNB/NW via the RRC signaling and the PUSCH is scheduled based on the CG Type II in response to the UE receiving a DCI format from the gNB/NW, the received DCI format may specify a first MCS value for the first codeword and a second MCS value for the second codeword, and both the NDI and RV values in the received DCI format may be set to zero for both codewords. The UE may receive a particular IE, such as the ConfiguredGrantConfigure IE without the rrc-ConfiguredUplinkGrant IE, in the RRC signaling and may obtain two RV sequences (e.g., repK-RV and repK2-RV) for each of the two codewords. The function of the RV sequence may be used to indicate the redundant information, such as redundancy versions, to be applied to each PUSCH repetition if a particular parameter in the CG configuration, such as repK, is configured. If any of the two RV sequences is not configured, the UE may apply RV=0 for the corresponding TB (or codeword) of the PUSCH transmission. The parameters for each codeword may be configured according to the corresponding scenario for each codeword.

In some implementations, if the UE is configured with a two-codeword transmission by the gNB/NW via the RRC signaling and the PUSCH is scheduled based on the CG Type I via the RRC signaling received from the gNB/NW, the UE may obtain one or more parameters for each codeword based on a particular IE, such as the ConfiguredGrantConfigure IE along with the rrc-ConfiguredUplinkGrant IE, in the RRC signaling. For example, the particular IE may include a field (e.g., the mcsAndTBS field in the rrc-ConfiguredUplinkGrant IE) that indicates a first MCS value for a first codeword and may also include a field (e.g., the mcsAndTBS2 field in the rrc-ConfiguredUplinkGrant IE) that indicates a second MCS value for a second codeword. Additionally, or alternatively, the particular IE may include a field (e.g., the repK-RV field in the ConfiguredGrantConfigure IE) that indicates the first RV value for the first codeword and may also include a field (e.g., the repK2-RV field in the ConfiguredGrantConfigure IE) that indicates the second RV value for the second codeword. The IEs/field/parameters for each codeword may be configured according to the corresponding scenario for each codeword.

In some implementations, if the UE receives the PUSCH-Config IE including the field xConfig from the gNB/NW in RRC signaling, and the field xConfig is set to ‘codebook,’ the UE may perform a CB PUSCH transmission. If the UE is configured by the gNB/NW to support a partial coherent codebook subset, and the UE has eight antenna ports and two antenna groups, the transmission precoding matrix indicated by the gNB/NW may include (e.g., consist of) two full coherent precoding matrices from the Rel-15 4TX codebook. Each full coherent precoding matrix may include a TPMI and the number of layers. Each full coherent precoding matrix may be mapped to an index of a dedicated table through a one-to-one mapping. The gNB/NW may inform the UE of the precoding information by transmitting a particular value through the DCI signaling (e.g., the field associated with the information of precoding and the number of layers, or the field associated with the second precoding information) or through the RRC signaling (e.g., the field precodingAndNumberOfLayers or the field precodingAndNumberOfLayers2-r17). The particular value may be formed by concatenating two indicated indices from the dedicated table. For example, if the bit width of the dedicated table is five, and the gNB/NW indicates two indices, ‘1’ and ‘3,’ with the first codepoint corresponding to ‘1’ as ‘00001’ and the second codepoint corresponding to ‘3’ as ‘00011’, then the bits (the particular value) formed by concatenating the first and second codepoints may appear as ‘0000100011’ in the field. Additionally, the value provided in the field precodingAndNumberOfLayers or in the field precodingAndNumberOfLayers2-r17 may be 34.

In some implementations, if a UE receives the PUSCH-Config IE including the field xConfig from the gNB/NW in the RRC signaling, and the field xConfig is set to ‘codebook,’ the UE may perform a CB PUSCH transmission. If the UE is configured by the gNB/NW to support a partial coherent codebook subset, and the UE has eight antenna ports and two antenna groups, the transmission precoding matrix indicated by the gNB/NW may include (e.g., consist of) two full coherent precoding matrices from the Rel-15 4TX codebook. Each full coherent precoding matrix may be mapped to an index of a first dedicated table through a one-to-one mapping. The gNB/NW may inform the UE of the precoding information by transmitting a particular value through the DCI signaling (e.g., the field associated with the information of precoding and the number of layers, or the field associated with the second precoding information) or through the RRC signaling (e.g., the field precodingAndNumberOfLayers or the field precodingAndNumberOfLayers2-r17).

The particular value from a dedicated table may be represented as a combination of two indicated indices. That is, each combination may be mapped to an index of the dedicated table through a one-to-one mapping. For example, if the gNB/NW indicates two indices in a first dedicated table related to the Rel-15 4TX precoding matrices, these two indicated indices may be mapped to one unique index (the particular value) in a second dedicated table associated with the combination of the indicated precoding indices. Moreover, the gNB/NW may transmit the precoding information to the UE by carrying the particular value through the DCI signaling or RRC signaling. For example, the field associated with the information of precoding and the number of layers, the field associated with the second precoding information, the field precodingAndNumberOfLayers, or the field precodingAndNumberOfLayers2-r17 may be set to the particular value.

In some implementations, if the UE receives the PUSCH-Config IE including the field xConfig from the gNB/NW in the RRC signaling, and the field xConfig is set to ‘codebook,’ the UE may perform a CB PUSCH transmission. If the UE is configured by the gNB/NW to support a partial coherent codebook subset, and the UE has eight antenna ports and four antenna groups, the transmission precoding matrix indicated by the gNB/NW may include (or consist of) four full coherent precoding matrices from the Rel-15 2TX codebook. Each full coherent precoding matrix may indicate a TPMI and the number of layers. Each full coherent precoding matrix may be mapped to an index of a dedicated table through a one-to-one mapping. The gNB/NW may indicate the precoding information by providing a particular value through the DCI signaling (e.g., the field associated with the information of precoding and the number of layers, or the field associated with the second precoding information) or through the RRC signaling (e.g., the field precodingAndNumberOfLayers or the field precodingAndNumberOfLayers2-r17). The particular value may be formed by concatenating four indicated indices from the dedicated table. For example, if the bit width of the dedicated table is two, the gNB/NW indicates four indices (e.g., ‘1,’ ‘2,’ ‘3,’ and ‘4’), the bits (the particular value) in the field associated with the information of precoding and the number of layers or the field associated with the second precoding information may be ‘00011011’. Additionally, the particular value in the field precodingAndNumberOfLayers or the field precodingAndNumberOfLayers2-r17 may be 27.

In some implementations, if the UE receives the PUSCH-Config IE including the field xConfig from the gNB/NW in RRC signaling, and the field xConfig is set to ‘codebook,’ the UE may perform a CB PUSCH transmission. If the UE is configured by the gNB/NW to support a partial coherent codebook subset, and the UE has eight antenna ports and four antenna groups, the transmission precoding matrix indicated by the gNB/NW may include (e.g., consist of) two full coherent precoding matrices from the Rel-15 2TX codebook. Each full coherent precoding matrix may be mapped to an index of a first dedicated table through a one-to-one mapping. The gNB/NW may indicate precoding information by providing a particular value through the DCI signaling (e.g., the field associated the information of precoding and the number of layers, or the field associated with the second precoding information) or through the RRC signaling (e.g., the field precodingAndNumberOfLayers or the field precodingAndNumberOfLayers2-r17). The particular value from a second dedicated table may be represented as a combination of four indicated indices. That is, each indicated combination may be mapped to an index of the second dedicated table through a one-to-one mapping. For example, if the gNB/NW indicates four indices in the first dedicated table related to Rel-15 2TX precoding matrices, these four indices may be mapped to one unique index (the particular value) in the second dedicated table associated with the combination of the indicated precoding indices. Moreover, the gNB/NW may transmit the precoding information to the UE by carrying the particular value through the DCI signaling or RRC signaling. For example, the field associated with the information of precoding and the number of layers, the field associated with the second precoding information, the field precodingAndNumberOfLayers, or the field precodingAndNumberOfLayers2-r17 may be set to the particular value.

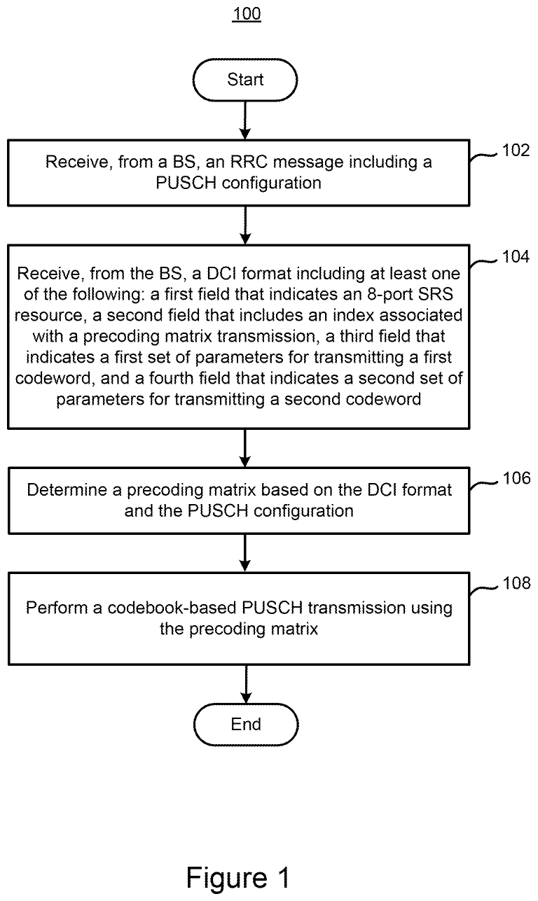

FIG. 1 is a flowchart of a method/process 100 for UL transmission enhancement, according to an example implementation of the present disclosure. It should be noted that although actions 102, 104, 106, and 108 are illustrated as separate actions, represented as independent blocks, in FIG. 1, these separately illustrated actions should not be construed as necessarily order-dependent. The order in which the actions are performed in FIG. 1 is not intended to be construed as a limitation, and any number of the disclosed blocks may be combined in any order to implement the method, or an alternative method. Moreover, each of actions 102, 104, 106, and 108 may be performed independently of other actions and may be omitted in some implementations of the present disclosure. The process 100 may be performed by a UE.

In action 102, the process 100 may start by receiving, from a BS, an RRC message including a PUSCH configuration.

In action 104, the process 100 may receive, from the BS, a DCI format including at least one of the following: a first field that indicates an 8-port SRS resource, a second field that includes an index associated with a precoding matrix transmission, a third field that indicates a first set of parameters for transmitting a first codeword, and a fourth field that indicates a second set of parameters for transmitting a second codeword.

In action 106, the process 100 may determine a precoding matrix based on the DCI format and the PUSCH configuration.

In action 108, the process 100 may perform a codebook-based PUSCH transmission using the precoding matrix. It should be noted that in the present disclosure, the terms “codebook-based PUSCH transmission” and “CB PUSCH transmission” may be used interchangeably. The process 100 may then end.

In some implementations, the first set of parameters may include a first MCS associated with the first codeword, a first NDI associated with the first codeword, and a first RV associated with the first codeword, and the second set of parameters may include a second MCS associated with the second codeword, a second NDI associated with the second codeword, and a second RV associated with the second codeword. For example, the PUSCH configuration may include a PUSCH-Config IE that includes the first set of parameters and the second set of parameters. Each set of parameters may include at least one of the following fields/parameters associated with the corresponding codeword: the txConfig field, the mcs-Table field, the mcs-TableTransformPrecoder field, the transformPrecoder field, the codebookSubset field, the codebookSubsetDCI-0-2-r16 field, the maxRank field, maxRankDCI-0-2-r16 field, the mcs-TableDCI-0-2-r16 field, and the mcs-TableTransformPrecoderDCI-0-2-r16 field.

In some implementations, the UE may further determine whether a two-codeword transmission function is enabled based on the RRC message, and determine that the fourth field is absent from the DCI format in response to determining that the two-codeword transmission function is disabled. In some implementations, the codebook-based PUSCH transmission in action 108 may be a two-codeword transmission for transmitting the first codeword and the second codeword if the two-codeword transmission function is enabled.

In some implementations, the PUSCH configuration may include a PUSCH-Config IE (e.g., as described in the present disclosure) that includes a txConfig field set to a value of ‘codebook.’ Alternatively, or additionally, the PUSCH-Config IE in the PUSCH configuration may include information associated with a number of maximum transmission ranks (e.g., the maxRank field and/or the maxRankDCI-0-2-r16 field), a transform precoding configuration (e.g., the transformPrecoder field), and a codebook subset configuration (e.g., the codebookSubset field and/or the codebookSubsetDCI-0-2-r16 field).

In some implementations, action 106 may include the UE determining a dedicated table, which includes the precoding matrix, based on the number of maximum transmission ranks, the transform precoding configuration, and the codebook subset configuration in the PUSCH-Config IE.

In some implementations, the number of maximum transmission ranks may be one of 1, 2, 4, and 8, and the codebook subset configuration may include one or more allowed codebook subsets and antenna group information.

In some implementations, the first field may include an SRS resource indicator field.

In some implementations, the second field may be associated with precoding information and a number of layers.

The technical effects of the method 100 for UL transmission enhancement include the capability of the DCI format to encapsulate parameters for two-codeword transmissions. Specifically, this arrangement may allow the UE to conduct a two-codeword transmission using the first and second sets of parameters received in the DCI format. By utilizing the DCI format, the method 100 enhances UL transmission flexibility and efficiency, enabling the network to adapt transmission strategies based on UE capabilities, optimizing radio resource utilization, and potentially increasing UL communication throughput and reliability. This method is in line with advanced MIMO configurations and sophisticated precoding strategies, improving network performance and user service quality.

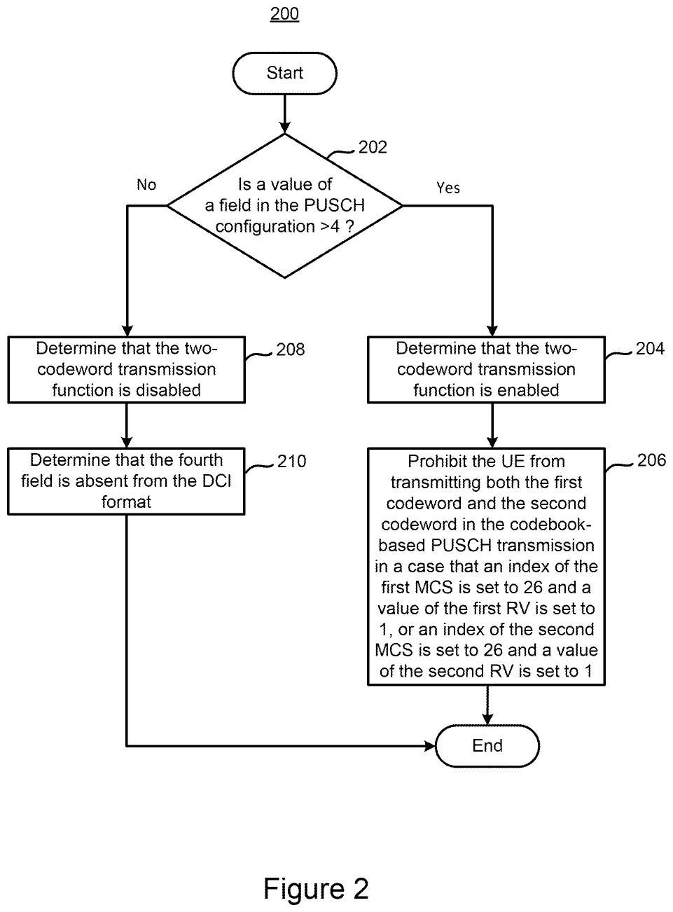

FIG. 2 is a flowchart of a method/process 200 for UL transmission enhancement, according to an example implementation of the present disclosure. The method 200 may be seen as either a continuation of the earlier mentioned methods, including the method 100, with additional detailed actions for mobility enhancement, or as a standalone approach offering a different or more detailed way to enhance mobility. Moreover, the method/process 200 may be integrated with the method/process 100 and/or other methods described in the present disclosure. Additionally, the method 200 uses terminology that is consistent with or corresponds to the terminology utilized in the method 100.

In some implementations, the PUSCH configuration may include a field (e.g., maxRank) indicating a maximum transmission rank for the codebook-based PUSCH transmission. In action 202, the UE may determine whether a value of the field is larger than four.

In action 204, the process 200 may start by determining that a two-codeword transmission function is enabled in response to determining that the value of the field is larger than four.

In action 206, in response to determining that the two-codeword transmission function is enabled, the process 200 may prohibit the UE from transmitting both the first codeword and the second codeword in the codebook-based PUSCH transmission in a case that an index of the first MCS is set to 26 and a value of the first RV is set to 1, or an index of the second MCS is set to 26 and a value of the second RV is set to 1.

In action 208, the process 200 may determine that the two-codeword transmission function is disabled in response to determining that the value of the field is equal to or less than four.

In action 210, the process 200 may determine that the fourth field is absent from the DCI format in response to determining that the two-codeword transmission function is disabled. The process 200 may then end.

It should be noted that in the present disclosure, the BS may perform methods/actions corresponding to those performed by the UE. For example, the receiving actions performed by the UE may correspond to the transmitting/configuring actions of the BS; the transmitting actions performed by the UE may correspond to the receiving actions of the BS. That is, the BS and the UE may have reciprocally aligned roles in transmission and reception. Furthermore, for certain operations, both the UE and the BS may have a mutual understanding of the timer operations. For example, the BS may anticipate, expect, or determine when the UE starts a timer and when the timer is expected to expire or stop. This synchronized understanding allows for coordinated actions, ensuring that the network and UE are in sync for critical operations, such as handover or reconfiguration.

For example, when viewed from the BS's perspective, the method 100 in FIG. 1 may correspond to a method performed by a BS. The BS may transmit an RRC message to a UE. The RRC may include a PUSCH configuration. The BS may further transmit a DCI format to the UE to enable the UE to determine a precoding matrix based on the DCI format and perform a codebook-based PUSCH transmission using the precoding matrix, where the DCI format may include at least one of the following: a first field that indicates an 8-port SRS resource, a second field that includes an index associated with a precoding matrix transmission, a third field that indicates a first set of parameters for transmitting a first codeword, and a fourth field that indicates a second set of parameters for transmitting a second codeword.

In some implementations, the first set of parameters may include a first MCS associated with the first codeword, a first NDI associated with the first codeword, and a first RV associated with the first codeword, and the second set of parameters may include a second MCS associated with the second codeword, a second NDI associated with the second codeword, and a second RV associated with the second codeword.

In some implementations, the PUSCH configuration may include a PUSCH-Config IE that includes a txConfig field set to a value of ‘codebook.’

In some implementations, the PUSCH configuration may include a PUSCH-Config IE that includes information associated with a number of maximum transmission ranks, a transform precoding configuration, and a codebook subset configuration.

In some implementations, the number of maximum transmission ranks may be one of 1, 2, 4, and 8, and the codebook subset configuration may include one or more allowed codebook subsets and antenna group information.

In some implementations, the first field may include an SRS resource indicator field.

In some implementations, the second field may be associated with precoding information and the number of layers.

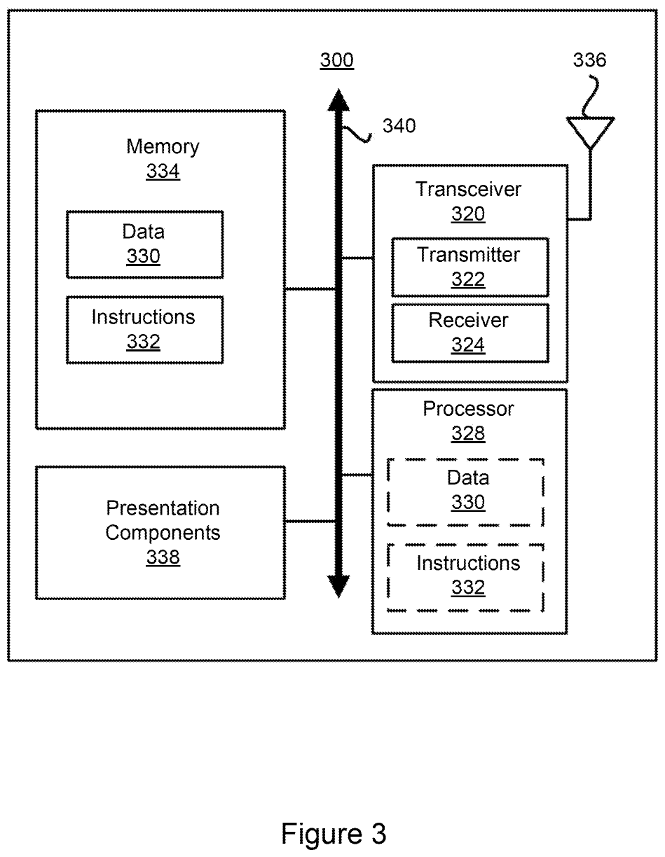

FIG. 3 is a block diagram illustrating a node 300 for wireless communications, in accordance with various aspects of the present disclosure. As illustrated in FIG. 3, node 300 may include transceiver 320, processor 328, memory 334, one or more presentation components 338, and at least one antenna 336. Node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. Node 300 may be a UE or a BS that performs various functions disclosed with reference to FIGS. 1 through 2.

Transceiver 320 has transmitter 322 (e.g., transmitting/transmission circuitry) and receiver 324 (e.g., receiving/reception circuitry) and may be configured to transmit and/or receive time and/or frequency resource partitioning information. Transceiver 320 may be configured to transmit in different types of subframes and slots including, but not limited to, usable, non-usable, and flexibly usable subframes and slot formats. Transceiver 320 may be configured to receive data and control channels.

Node 300 may include a variety of computer-readable media. Computer-readable media may be any available media that may be accessed by node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

Memory 334 may include computer-storage media in the form of volatile and/or non-volatile memory. Memory 334 may be removable, non-removable, or a combination thereof. Example memory may include solid-state memory, hard drives, optical-disc drives, etc. As illustrated in FIG. 3, memory 334 may store a computer-readable and/or computer-executable instructions 332 (e.g., software codes) that are configured to, when executed, cause processor 328 to perform various functions disclosed herein, for example, with reference to FIGS. 1 through 2. Alternatively, instructions 332 may not be directly executable by processor 328 but may be configured to cause node 300 (e.g., when compiled and executed) to perform various functions disclosed herein.

Processor 328 (e.g., having processing circuitry) may include an intelligent hardware device, e.g., a Central Processing Unit (CPU), a microcontroller, an ASIC, etc. Processor 328 may include memory. Processor 328 may process data 330 and instructions 332 received from memory 334, and information transmitted and received via transceiver 320, the baseband communications module, and/or the network communications module. Processor 328 may also process information to send to transceiver 320 for transmission via antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for Uplink (UL) transmission enhancement, the method comprising:
receiving, from a Base Station (BS), a Radio Resource Control (RRC) message comprising a Physical Uplink Shared Channel (PUSCH) configuration;
receiving, from the BS, a Downlink Control Information (DCI) format comprising at least one of:
a first field that indicates an 8-port Sounding Reference Signal (SRS) resource, a second field that includes an index associated with a precoding matrix transmission,
a third field that indicates a first set of parameters for transmitting a first codeword, and
a fourth field that indicates a second set of parameters for transmitting a second codeword;
determining a precoding matrix based on the DCI format and the PUSCH configuration; and
performing a codebook-based PUSCH transmission using the precoding matrix.

2. The method of claim 1, wherein:
the first set of parameters comprises a first Modulation and Coding Scheme (MCS) associated with the first codeword, a first New Data Indicator (NDI) associated with the first codeword, and a first Redundancy Version (RV) associated with the first codeword, and
the second set of parameters comprises a second MCS associated with the second codeword, a second NDI associated with the second codeword, and a second RV associated with the second codeword.

3. The method of claim 2, wherein the PUSCH configuration comprises a field indicating a maximum transmission rank for the codebook-based PUSCH transmission, the method further comprising:
determining whether a value of the field is larger than four;
determining that a two-codeword transmission function is enabled in response to determining that the value of the field is larger than four; and
in response to determining that the two-codeword transmission function is enabled:
prohibiting the UE from transmitting both the first codeword and the second codeword in the codebook-based PUSCH transmission in a case that
an index of the first MCS is set to 26 and a value of the first RV is set to 1, or
an index of the second MCS is set to 26 and a value of the second RV is set to 1.

4. The method of claim 3, further comprising:
determining that the two-codeword transmission function is disabled in response to determining that the value of the field is equal to or less than four; and
determining that the fourth field is absent from the DCI format in response to determining that the two-codeword transmission function is disabled.

5. The method of claim 1, wherein the PUSCH configuration comprises a PUSCH-Config Information Element (IE) that includes a xConfig field set to a value of ‘codebook.’

6. The method of claim 1, wherein the PUSCH configuration comprises a PUSCH-Config Information Element (IE) that includes information associated with a number of maximum transmission ranks, a transform precoding configuration, and a codebook subset configuration.

7. The method of claim 6, wherein determining the precoding matrix based on the DCI format comprises:
determining a dedicated table, which comprises the precoding matrix, based on the number of maximum transmission ranks, the transform precoding configuration, and the codebook subset configuration in the PUSCH-Config IE.

8. The method of claim 6, wherein:
the number of maximum transmission ranks is one of 1, 2, 4, and 8, and
the codebook subset configuration comprises one or more allowed codebook subsets and antenna group information.

9. The method of claim 1, wherein the first field comprises an SRS resource indicator field.

10. The method of claim 1, wherein the second field is associated with precoding information and a number of layers.

11. A User Equipment (UE) for Uplink (UL) transmission enhancement, the UE comprising:
at least one processor; and
at least one non-transitory computer-readable medium coupled to the at least one processor and storing one or more computer-executable instructions that, when executed by the at least one processor, cause the UE to:
receive, from a Base Station (BS), a Radio Resource Control (RRC) message comprising a Physical Uplink Shared Channel (PUSCH) configuration;
receive, from the BS, a Downlink Control Information (DCI) format comprising at least one of:
a first field that indicates an 8-port Sounding Reference Signal (SRS) resource,
a second field that includes an index associated with a precoding matrix transmission,
a third field that indicates a first set of parameters for transmitting a first codeword, and
a fourth field that indicates a second set of parameters for transmitting a second codeword;
determine a precoding matrix based on the DCI format and the PUSCH configuration; and
perform a codebook-based PUSCH transmission using the precoding matrix.

12. The UE of claim 11, wherein:
the first set of parameters comprises a first Modulation and Coding Scheme (MCS) associated with the first codeword, a first New Data Indicator (NDI) associated with the first codeword, and a first Redundancy Version (RV) associated with the first codeword, and
the second set of parameters comprises a second MCS associated with the second codeword, a second NDI associated with the second codeword, and a second RV associated with the second codeword.

13. The UE of claim 12, wherein the PUSCH configuration comprises a field indicating a maximum transmission rank for the codebook-based PUSCH transmission, and the one or more computer-executable instructions, when executed by the at least one processor, further cause the UE to:
determine whether a value of the field is larger than four;
determine that a two-codeword transmission function is enabled in response to determining that the value of the field is larger than four; and
in response to determining that the two-codeword transmission function is enabled:
prohibit the UE from transmitting both the first codeword and the second codeword in the codebook-based PUSCH transmission in a case that
an index of the first MCS is set to 26 and a value of the first RV is set to 1, or
an index of the second MCS is set to 26 and a value of the second RV is set to 1.

14. The UE of claim 13, wherein the one or more computer-executable instructions, when executed by the at least one processor, further cause the UE to:
determine that the two-codeword transmission function is disabled in response to determining that the value of the field is equal to or less than four; and
determine that the fourth field is absent from the DCI format in response to determining that the two-codeword transmission function is disabled.

15. The UE of claim 11, wherein the PUSCH configuration comprises a PUSCH-Config Information Element (IE) that includes a xConfig field set to a value of ‘codebook.’

16. The UE of claim 11, wherein the PUSCH configuration comprises a PUSCH-Config Information Element (IE) that includes information associated with a number of maximum transmission ranks, a transform precoding configuration, and a codebook subset configuration.

17. The UE of claim 16, wherein determining the precoding matrix based on the DCI format comprises:
determining a dedicated table, which comprises the precoding matrix, based on the number of maximum transmission ranks, the transform precoding configuration, and the codebook subset configuration in the PUSCH-Config IE.

18. The UE of claim 16, wherein:
the number of maximum transmission ranks is one of 1, 2, 4, and 8, and the codebook subset configuration comprises one or more allowed codebook subsets and antenna group information.

19. The UE of claim 11, wherein the first field comprises an SRS resource indicator field.

20. The UE of claim 11, wherein the second field is associated with precoding information and a number of layers.

21. A Base Station (BS), comprising:
at least one processor; and
at least one non-transitory computer-readable medium coupled to the at least one processor and storing one or more computer-executable instructions that, when executed by the at least one processor, cause the BS to:
transmit a Radio Resource Control (RRC) message to a User Equipment (UE), the RRC message comprising a Physical Uplink Shared Channel (PUSCH) configuration; and
transmit a Downlink Control Information (DCI) format to the UE to enable the UE to determine a precoding matrix based on the DCI format and the PUSCH configuration and perform a codebook-based PUSCH transmission using the precoding matrix,
wherein the DCI format comprises at least one of:
a first field that indicates an 8-port Sounding Reference Signal (SRS) resource,
a second field that includes an index associated with a precoding matrix transmission,
a third field that indicates a first set of parameters for transmitting a first codeword, and
a fourth field that indicates a second set of parameters for transmitting a second codeword.

22. The BS of claim 21, wherein:
the first set of parameters comprises a first Modulation and Coding Scheme (MCS) associated with the first codeword, a first New Data Indicator (NDI) associated with the first codeword, and a first Redundancy Version (RV) associated with the first codeword, and
the second set of parameters comprises a second MCS associated with the second codeword, a second NDI associated with the second codeword, and a second RV associated with the second codeword.

23. The BS of claim 21, wherein the PUSCH configuration comprises a PUSCH-Config Information Element (IE) that includes a xConfig field set to a value of ‘codebook.’

24. The BS of claim 21, wherein the PUSCH configuration comprises a PUSCH-Config Information Element (IE) that includes information associated with a number of maximum transmission ranks, a transform precoding configuration, and a codebook subset configuration.

25. The BS of claim 24, wherein:
the number of maximum transmission ranks is one of 1, 2, 4, and 8, and
the codebook subset configuration comprises one or more allowed codebook subsets and antenna group information.

26. The BS of claim 21, wherein the first field comprises an SRS resource indicator field.

27. The BS of claim 21, wherein the second field is associated with precoding information and a number of layers.
